(19) United States
(12) Patent Application Publication
(10) Pub. No.: US 2009/0254304 A1
(43) Pub. Date: Oct. 8, 2009

(54) Pedometer for running

(76) Inventor: Keisuke Tsubata, Chiba-shi (JP)

Correspondence Address: BRUCE L. ADAMS, ESQ.;ADAMS & WILKS, 17 BATTERY PLACE- SUITE 1231, NEW YORK, NY, 10004, US

(21) Appl. No.: 12/384,504

(22) Filed: Apr. 6, 2009

(30) Foreign Application Priority Data
Apr. 8, 2008 (JP) 2008-100396

(51) Int. Cl. G01C 22/00

(52) U.S. Cl. 702/160; 377/24.2

(57) ABSTRACT

To be able to downsize and to be able to accurately measure a step number in running in a pedometer of measuring the step number by wearing at least a step number sensor to the wrist, a step number sensor of detecting running is arranged such that an angle of a longitudinal direction of a strap and a sensitivity axis of the step number sensor is disposed within a range from 10 degrees to 33 degrees in the clockwise direction relative to the longitudinal direction of the strap. A user of the pedometer for running mounts a pedometer main body to the back side of the left wrist of one's own by the strap, starts a pedometer measuring processing by inputting means and starts measuring a step number by starting running. Measured step number and time are displayed on displaying means.

### BACKGROUND OF THE INVENTION

1. Field of the Invention

The present invention relates to a pedometer for running of measuring a running step number by detecting running of a user.

2. Description of the Related Art

In a related art, there is developed a pedometer for measuring a step number of a user by using a step number sensor.

As the pedometer, there is developed a pedometer of a wristwatch type used by being mounted to the wrist of a user as in a wristwatch (refer to, for example, Japanese Patent Publication No. 2712269).

According to the pedometer of the related art, a sensitivity of an axis of a sensor of measuring a step number is set in 12 o'clock-6 o'clock direction. Therefore, in a form of running by hanging down the arm, a large signal generated when the arm is pushed forward and a small signal generated when the wrist is pushed rearward are alternately generated step by step. When the small signal cannot exceed a threshold capable of recognizing the signal of the step number, there poses a problem that accurate step number measurement cannot be carried out.

On the other hand, in Japanese Patent Publication JP-A-2005-309693, there is disclosed a pedometer for walking in which a sensitivity axis is set to a predetermined value in order to measure a step number in walking. The pedometer described in JP-A-2005-309693 is a pedometer for measuring the step number in walking and measurement of a step number in running is not taken into consideration. Therefore, there poses a problem that it is difficult to accurately measure a step number in running by using the pedometer for walking.

### SUMMARY OF THE INVENTION

It is an object of the invention to be able to be downsized and to be able to accurately measure a step number in running in a pedometer for measuring the step number by mounting at least a step number sensor to the wrist.

According to the invention, there is provided a pedometer for running including a step number sensor of outputting a step number signal in correspondence with running by detecting the running of a user, counting means for counting a step number of the user based on the step number signal, and a strap for mounting at least the step number sensor to the wrist of the user and used by mounting at least the step number sensor to the wrist of the user by the strap, wherein a sensitivity axis of the step number sensor is arranged to be disposed in a range from 10 degrees within 33 degrees around the clockwise direction relative to a longitudinal direction of the strap, or a range from 10 degrees within 33 degrees in the counterclockwise direction relative to the longitudinal direction of the strap.

The sensitivity axis of the step number sensor is arranged to be disposed in the range from 10 degrees within 33 degrees in the clockwise direction relative to the longitudinal direction of the strap, or the range from 10 degrees within 33 degrees in the counterclockwise direction relative to the longitudinal direction of the strap, and therefore, a proper signal in correspondence with running is provided from the step number sensor and the accurate step number is measured.

Here, there may be constructed a constitution in which the pedometer is used by being mounted to the back side of the left wrist of the user when the sensitivity axis of the step number sensor is arranged to be disposed in the range from 10 degrees within 33 degrees in the clockwise direction relative to the longitudinal direction of the strap, and used by being mounted to the back side of the right wrist of the user when the sensitivity axis of the step number sensor is arranged to be disposed in the range from 10 degrees within 33 degrees in the counterclockwise direction relative to the longitudinal direction of the strap.

Further, there may be constructed a constitution in which the step number sensor is an acceleration sensor.

Further, there may be constructed a constitution in which the pedometer further comprises counting means for counting.

According to the invention, the running can be detected by using the single step number sensor, and therefore, downsizing thereof can be carried out, and accurate detection of running which is constituted such that the sensitivity axis of the step number sensor constitutes the predetermined angle in being used can be carried out.

Further, a pedometer having a function as a wristwatch can be constituted and the step number in running can be measured out in normal living.

### BRIEF DESCRIPTION OF THE DRAWINGS

FIG. 1 is a block diagram of a pedometer for running according to an embodiment of the invention;

FIG. 2 is a front view of an outlook of the pedometer according to the embodiment of the invention;

FIG. 3 is a partial inner constitution view of the pedometer according to the embodiment of the invention;

FIG. 4 is a view showing a mode of using the pedometer according to the embodiment of the invention;

FIGS. 5A and 5B are views showing a mode of using the pedometer according to the embodiment of the invention;

FIGS. 6A and 6B are waveform diagrams for explaining an operation of the pedometer according to the embodiment of the invention, and FIG. 6C shows a peak value average of a small level signal; and

FIGS. 7A and 7B are characteristic diagrams for explaining an operation of the pedometer according to the embodiment of the invention.

### DETAILED DESCRIPTION OF THE PREFERRED EMBODIMENTS

A pedometer for running according to an embodiment of the invention is a pedometer for running of a wristwatch type used by being mounted to the wrist of a user by a strap, includes a step number sensor of detecting running of the user and outputting a step number signal in correspondence with the running, counting means for counting a step number of the user based on the step number signal, and a strap for mounting at least the step number sensor to the back side of the wrist of the user, and is used by mounting at least the step number sensor to the back side of the wrist of the user by the strap. The pedometer for running according to the embodiment will be explained in reference to the drawings as follows. Further, in respective drawings, the same portions are attached with the same notations.

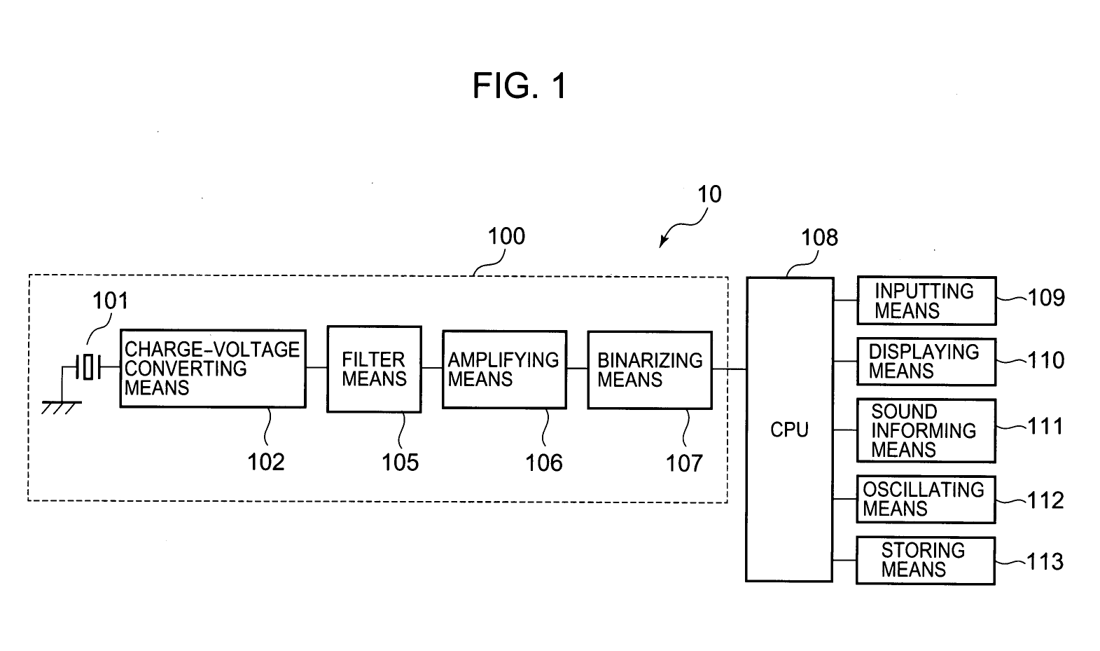

FIG. 1 is a block diagram of a pedometer 10 for running according to the embodiment of the invention.

In FIG. 1, a pedometer 10 includes a running detecting circuit 100, a central processing unit (CPU) 108 of carrying out a step number measuring processing or the like based on a step number signal from the running detecting circuit 100, inputting means 109 constituted by an operating switch or the like for carrying out various operations of a step number measuring start operation and the like, displaying means 110 for displaying a measured step number, current time and the like, sound informing means 111 for alarming or the like by sound, oscillating means 112 for generating a signal constituting a basis of a reference clock signal for CPU 108 or time signal in carrying out counting operation, and storing means 113.

The running detecting circuit 100 includes one step number sensor (according to the embodiment, a piezoelectric element constituting an acceleration sensor) 101 of outputting a step number signal of an electric charge at every time of detecting running of a user in correspondence therewith, charge-voltage converting means 102 for converting the step number signal from the step number sensor 101 into a step number signal of a voltage in correspondence therewith, filter means 105 of outputting a step number signal by removing noise in a signal outputted from the charge-voltage converting means 102, amplifying means 106 for amplifying a step number signal from the filter means 105 to output, and binarizing means 107 for converting a step number signal in an analog signal style from the amplifying means 106 into a step number signal of a digital signal style.

Although details will be described later, according to the embodiment, an operational middle point of the amplifying means 106 is set to 0.9 V, when a step number signal exceeding the operational middle point is not inputted to the amplifying means 106, the step number signal from the amplifying means 106 is not outputted, and therefore, CPU 108 cannot detect the step number signal.

As the step number sensor 101, other step number sensor of a mechanical step number sensor or the like can also be used and the step number sensor is not limited to the acceleration sensor of the piezoelectric element or the like.

The storing means 113 is constituted by ROM stored with a program executed by CPU 108 and RAM used as a work region when CPU 108 executes the program, and RAM is stored with data of a measured step number and the like.

In accordance with the operation of the inputting means 109, CPU 108 can carry out time measurement of current time, a running time period or the like based on an oscillating signal from the oscillating means 112.

The binarizing means 107 is constituted by a comparator having a predetermined threshold.

CPU 108 carries out a step number counting processing based on the step number signal of the digital signal style inputted from the binarizing means 107, carries out a counting operation based on the signal from the oscillating means 112, further, carries out a control of respective constituent elements.

Further, the running detecting circuit 100 constitutes running detecting means and can output the binarized step number signal in correspondence with running of the user to CPU 108. CPU 108 constitutes counting means and can count the step number based on the step number signal from the step number sensor 101. Further, CPU 108 constitutes counting means, controlling means for controlling the respective constituent elements.

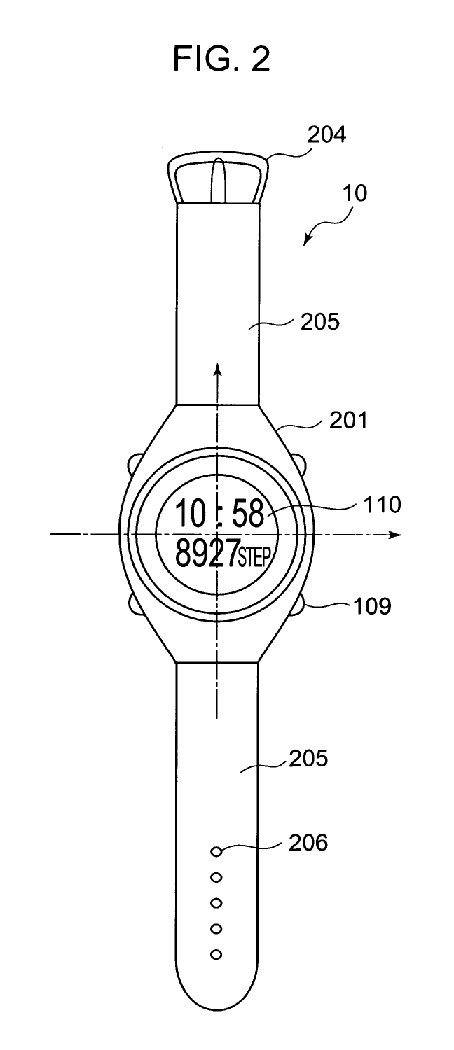

FIG. 2 is a front view of an outlook of the pedometer according to the embodiment of the invention, showing the wristwatch type pedometer 10 for running for the left hand used by being mounted to the back side of the left wrist of the user.

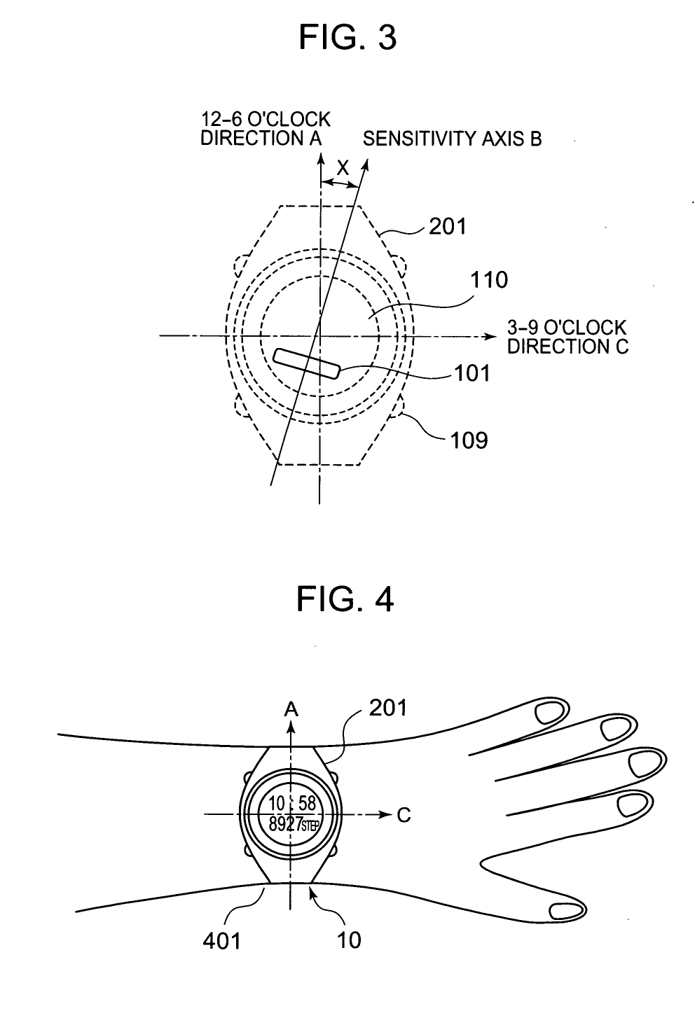

FIG. 3 is a view showing an inner constitution of a portion of FIG. 2.

In FIG. 2 and FIG. 3, the pedometer 10 for running includes a pedometer main body 201 having the displaying means 110 and the inputting means 109 having a plurality of operating switches capable of being operated from outside, a strap 205 for mounting the pedometer main body 201 to the wrist of the user, and a buckle 204 provided at an end portion of the strap 205.

The displaying means 110 displays a step number of running by the user, current time, a running time period or the like.

The strap 205 is provided with a plurality of small holes 206 and is constituted to mount the pedometer main body 201 to the back side of the left wrist of the user by the strap 205 by engaging the small hole 206 and the buckle 204.

An inner portion of the pedometer main body 201 is provided with the step number sensor 101 for detecting running of the user. Here, as the step number sensor 101, an acceleration sensor constituting an element capable of detecting an acceleration is used, the acceleration sensor is referred to also as a shock sensor, an impact sensor, a vibration sensor or the like and various acceleration sensors of a bimorph type, a unimorph type, a piezoelectric type and the like can be used.

Although a description will be given later of an angle X of a longitudinal direction A of the strap 205 and a sensitivity axis B of the step number sensor 101 in a state of mounting the pedometer main body 201 to the back side of the left wrist of the user, as shown by FIG. 4, the pedometer 10 shown in FIG. 2 and FIG. 3 is a pedometer for running for the left hand used by being mounted to the left wrist.

Therefore, the step number sensor 101 is constituted such that when the pedometer main body 201 is viewed from the side of the displaying means 110, the sensitivity axis B of the step number sensor 101 is arranged to the angle X from 10 degrees through within 33 degrees in the clockwise direction (that is, in 3 o'clock direction) relative to the longitudinal direction (that is, 12-6 o'clock direction) A of the strap 205. When a direction of moving the step number sensor 101 or a direction of an impact applied to the step number sensor 101 coincides with the sensitivity axis B, a detection sensitivity is maximized.

Further, in a case of a wristwatch type pedometer for running for the right arm used by mounting the pedometer main body 201 to the back side of the right wrist, the step number sensor 101 is arranged at a position at which the sensitivity axis B of the step number sensor 101 falls in a range from 10 degrees through within 33 degrees in the counterclockwise direction (that is, 9 o'clock direction) relative to the longitudinal direction A of the strap 205 when the pedometer main body 201 is viewed from the side of the displaying means 110.

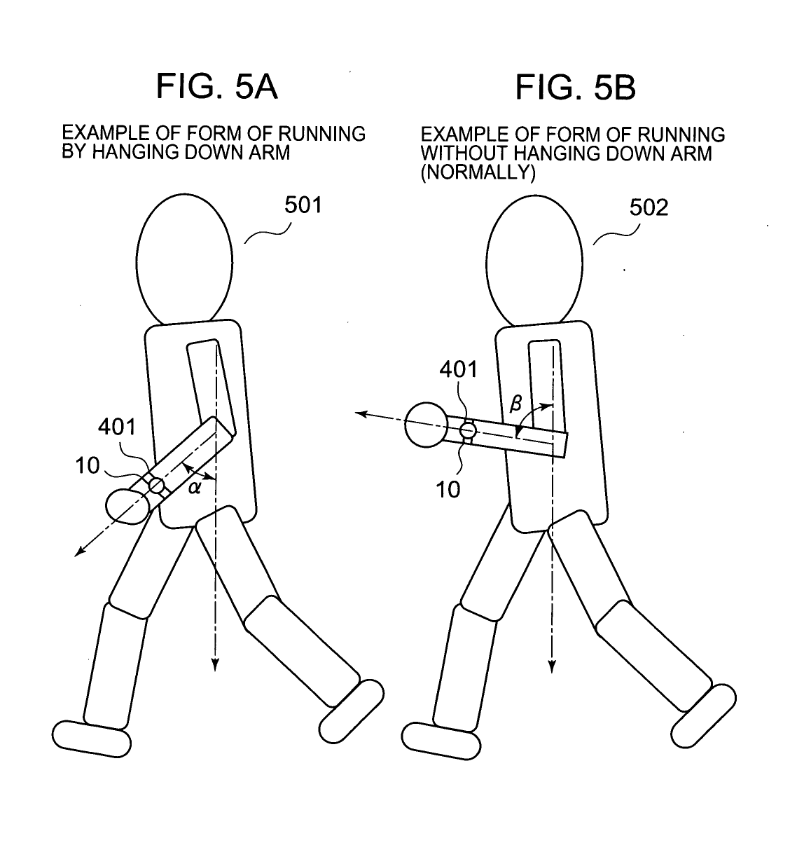

FIGS. 5A and 5B are explanatory views when the user mounts to use the running pedometer 10 according to the embodiment.

Generally, a center position in an up and down direction of swinging down in running differs by persons by respective habits of the persons. FIGS. 5A and 5B show an example of a person in which a center position of the arm is disposed at two extreme ends in an up and down direction based on a data of a result of carrying out a sample investigation.

That is, FIG. 5A shows a behavior in which a user 501 having a habit of running in a state of hanging down the arm runs by mounting the pedometer 10 at the left wrist 401. An angle α of a vertical direction and left arm falls in a range of 10 degrees through 15 degrees.

Further, FIG. 5B shows a behavior in which a user 502 having a habit of running in a state of hanging up the arm runs by mounting the pedometer 10 at the left wrist 401.

An angle β of a vertical direction and left arm falls in a range of 30 degrees through 45 degrees.

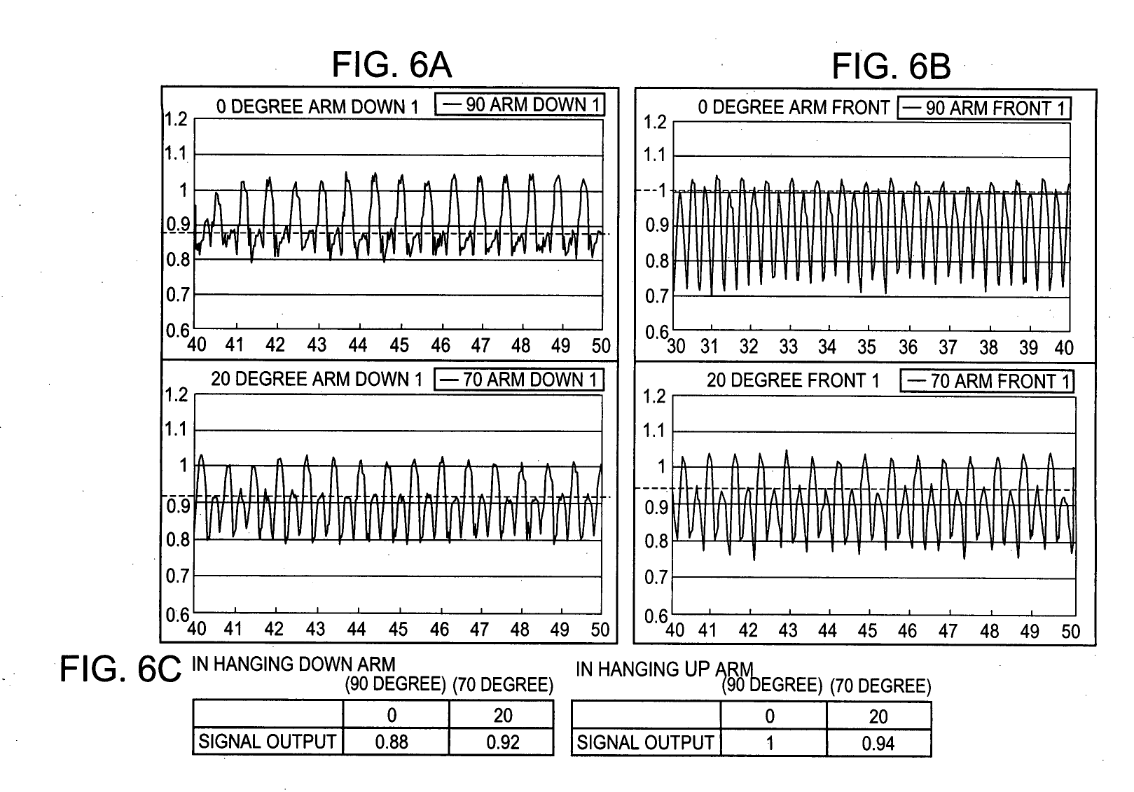

FIGS. 6A and 6B are signal waveform diagrams provided in a case of running by mounting the pedometer according to the embodiment.

FIG. 6A is a waveform diagram in a case of running while swinging the arm by hanging down the arm as shown by FIG. 5A, and FIG. 6B is a waveform diagram in a case of running while swinging the arm by hanging up the arm as shown by FIG. 5B. In either of the drawings, the ordinate designates an input signal level to the amplifying means 106 and the abscissa designates time.

Further, an upper diagram (0 degree arm down) of FIG. 6A is a waveform diagram when running by setting the angle X of the sensitivity axis B and the longitudinal direction A of the strap 205 to 0 degree and a lower diagram (20 degree arm down) of FIG. 6A is a waveform diagram when running by setting the angle X to 20 degrees.

Further, an upper diagram (0 degree arm front) of FIG. 6B is a waveform diagram when running by setting the angle X of the sensitivity axis B and the longitudinal direction A of the strap 205 to 0 degree, and a lower diagram (20 degree front 1) of FIG. 6B is a waveform diagram when running by setting the angle X to 20 degrees.

In FIGS. 6A and 6B, at respective steps of running, a signal of a large level and a signal of a small level are alternately provided, when the arm is pushed forward in running, the large level signal is provided and when the arm is pulled rearward, the small level signal is provided.

As shown by the upper diagram of FIG. 6A, when running in a state of 0 degree of the angle X and hanging down the arm as shown by FIG. 5A, the small level signal does not exceed 0.9 V constituting the operation middle point of the amplifying means 106 (as shown by left column of FIG. 6C, only 0.88 V of a peak value average of the small level signal is provided), and therefore, although a step number signal in correspondence with the large level is outputted from the amplifying means 106, a step number signal in correspondence with the small level is not outputted. Therefore, the accurate step number counting is not carried out at CPU 108.

As shown by the lower diagram of FIG. 6A, when running in a state of setting the angle X to 20 degrees, even the small level signal exceeds 0.9 V constituting the operation middle point of the amplifying means 106 (as shown by left column of FIG. 6C), 0.92 V of the peak value average of the small level signal is provided), and therefore, not only the step number signal in correspondence with the large level but also the step number signal in correspondence with the small level are outputted from the amplifying means 106. The step number signal is binarized by the binarizing means 107, thereafter, subjected to a counting processing step by step by CPU 108 and accurate step number counting is carried out.

On the other hand, as shown by an upper diagram and a lower diagram of FIG. 6B, when running in a state of setting the angle X to 0 degree or 20 degrees by hanging up the arm as shown by FIG. 5B, in either of the cases, the small level signal exceeds 0.9 V constituting the operation middle point of the amplifying means 106 (as shown by right column of FIG. 6C, 1 V and 0.94 V of the peak value averages of the small level signal are provided), and therefore, not only the step number signal in correspondence with the large level but also the step number signal in correspondence with the small level are outputted from the amplifying means 106. The step number signal is binarized by the binarizing means 107, thereafter, the accurate step number counting is carried out by CPU 108.

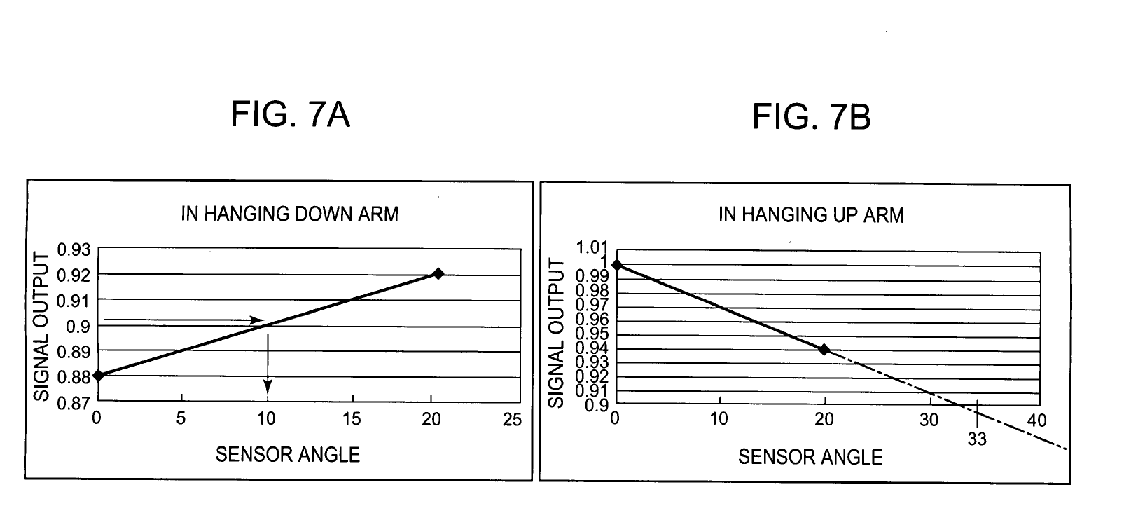

FIGS. 7A and 7B show changes in signal levels inputted to the amplifying means 106 when the angle X is changed respectively in the state of hanging down the arm and in the state of hanging up the arm.

FIG. 7A is a diagram showing an input signal level to the amplifying means 106 versus the angle X in the state of hanging down the arm and FIG. 7B is a diagram showing the input signal level to the amplifying means 106 versus the angle X in the state of hanging up the arm.

As shown by FIGS. 7A and 7B, in the state of hanging down the arm, when the angle X is equal to or larger than 10 degrees, the signal exceeding the operation middle point level 0.9 V of the amplifying means 106 is provided, further, in the state of hanging up the arm, when the angle X is equal to or smaller than 33 degrees, the signal exceeding the operation middle point level 0.9 V of the amplifying means 106 is provided.

Therefore, in the case of the wrist watch type pedometer 10 of a type of being used by mounting the pedometer main body 201 to the back side of the left wrist, by setting the angle X of the sensitivity axis B of the step number sensor 101 and the longitudinal direction A of the strap 205 to be from 10 degrees within 33 degrees in the clockwise direction relative to the longitudinal direction A of the strap 205, an accurate step number can be measured without being influenced by the position of the arm in running.

When used by being mounted to the back side of the right wrist of the user, by constituting the sensitivity axis B of the step number sensor 101 disposed in a range from 10 degrees within 33 degrees in the counterclockwise direction relative to the longitudinal direction A of the strap 205, accurate step number can be measured.

As described above, according to the pedometer for running according to the embodiment of the invention, the step number sensor 101 of detecting running is arranged such that the angle X of the longitudinal direction A of the strap and the sensitivity axis B of the step number sensor 101 is disposed within the range from 10 degrees to 33 degrees in the clockwise direction relative to the longitudinal direction A of the strap. The user of the pedometer 10 for running mounts the pedometer main body 201 to the back side of the left wrist of one's own, starts the step number measuring processing by the inputting means 109, and starts measuring the step number by starting running. The measured step number and time are constituted to display on the displaying means 110.

Therefore, in the pedometer for running for measuring the step number by mounting at least the step number sensor to the wrist, downsizing thereof can be carried out and the step number in running can accurately be measured.

Further, running can be detected by using the single step number sensor 101, and therefore, downsizing can be carried out, when the sensitivity axis B of the step number sensor 101 is used, the sensitivity axis B is constituted to constitute a predetermined angle relative to an impact brought about by running, and therefore, the impact can accurately be detected to achieve an effect of capable of accurately detecting running.

The invention is applicable also to a pedometer constituted to be used by mounting all of constituent elements of the pedometer to a user, a pedometer constituted to mount a portion of constituent elements (at least step number sensor) to the user and make other constituent elements transmit and receive a signal to the portion of constituent elements by wireless and providing the other constituent elements at a location remote from the user.

What is claimed is:

1. A pedometer for running comprising:
a step number sensor for outputting a step number signal in correspondence with running by detecting the running of a user;
counting means for counting a step number of the user based on the step number signal; and
a strap for mounting at least the step number sensor to the wrist of the user and used by mounting at least the step number sensor to the wrist of the user by the strap;
wherein a sensitivity axis of the step number sensor is arranged to be disposed in a range from 10 degrees within 33 degrees around the clockwise direction relative to a longitudinal direction of the strap, or a range from 10 degrees within 33 degrees in the counterclockwise direction relative to the longitudinal direction of the strap.

2. The pedometer for running according to claim 1, wherein the pedometer is used by being mounted to the back side of the left wrist of the user when the sensitivity axis of the step number sensor is arranged to be disposed in the range from 10 degrees within 33 degrees in the clockwise direction relative to the longitudinal direction of the strap, and used by being mounted to the back side of the right wrist of the user when the sensitivity axis of the step number sensor is arranged to be disposed in the range from 10 degrees within 33 degrees in the counterclockwise direction relative to the longitudinal direction of the strap.

3. The pedometer for running according to claim 1, wherein the step number sensor is an acceleration sensor.

4. The pedometer for running according to claim 2, wherein the step number sensor is an acceleration sensor.

5. The pedometer for running according to claim 1, further comprising:
counting means for counting time.

6. The pedometer for running according to claim 2, further comprising:
counting means for counting time.

7. The pedometer for running according to claim 3, further comprising:
counting means for counting time.

8. The pedometer for running according to claim 4, further comprising:
counting means for counting time.
